(19) United States
(12) Patent Application Publication
(10) Pub. No.: US 2026/0364923 A1
(43) Pub. Date: Nov. 19, 2026

(54) GLASS FOR BUILDINGS, VEHICLES, OR SENSORS, AND LAMINATED GLASS

(71) Applicant: AGC Inc., Tokyo (JP)

(72) Inventors: Takato KAJIHARA, Tokyo (JP); Shigeki SAWAMURA, Tokyo (JP); Mikio NAGANO, Tokyo (JP)

(73) Assignee: AGC Inc., Tokyo (JP)

(21) Appl. No.: 19/721,397

(22) Filed: Jun. 26, 2026

Related U.S. Application Data
(63) Continuation of application No. PCT/JP2024/045678, filed on Dec. 24, 2024.

(30) Foreign Application Priority Data
Dec. 27, 2023 (JP) 2023-221647

(51) Int. Cl. B32B 17/10; B32B 27/06; B32B 27/30; B32B 37/10; C03C 3/091

(52) U.S. Cl. CPC B32B 17/10036; B32B 17/10119; B32B 17/10137; B32B 17/10761; B32B 17/10816; B32B 17/10981; B32B 27/06; B32B 27/30; B32B 37/10; C03C 3/091; B32B 2307/102; B32B 2307/412; B32B 2307/72; B32B 2307/7376; B32B 2315/08; B32B 2329/06; B32B 2419/00; B32B 2457/00; B32B 2551/00; B32B 2605/08

(57) ABSTRACT

The present invention relates to a glass for a building, for a vehicle, or for a sensor, containing, in mol % in terms of oxides: SiO₂: 60% to 68%; Al₂O₃: 1.5% to 5.0%; B₂O₃: 0.0% to 5.0%; MgO: 0.0% to 10%; CaO: 10% to 20%; SrO: 0.0% to 10%; BaO: 0.0% to 5.0%; Li₂O: 0.0% to 10%; Na₂O: 0.0% to 20%; K₂O: 0.0% to 10%; Y₂O₃: 0.0% to 1.0%; total iron oxide in terms of Fe₂O₃: 0.0030% to 0.5%; SiO₂+Al₂O₃+B₂O₃: 62% to 70%; R′₂O: 14% to 20%; and RO: 10% to 20% (where RO represents a total content of MgO, CaO, SrO, and BaO, and R′₂O represents a total content of Li₂O, Na₂O, and K₂O).

### CROSS-REFERENCE TO RELATED APPLICATIONS

This is a continuation of International Application No. PCT/JP2024/045678 filed on Dec. 24, 2024, and claims priority under 35 USC 119 from Japanese Patent Application No. 2023-221647 filed on Dec. 27, 2023, the contents of which are incorporated herein by reference.

### TECHNICAL FIELD

The present invention relates to a glass for a building, for a vehicle, or for a sensor, and laminated glass.

### BACKGROUND ART

A glass for a building, for a vehicle, or for a sensor is used as, for example, a protective member of a sensor or a module. When an instantaneous impact is applied from the outside due to a collision of a fallen object, a collision of a flying stone during traveling, or the like, there is a concern that stress at the time of the collision is not relaxed, a concentrated stress is generated, and the glass as the protective member, sensor, or module may be damaged. Therefore, the glass is required to have excellent strength.

For example, Patent Literature 1 discloses a sensor module using a physically tempered glass or chemically tempered glass as a protective member. Patent Literature 2 describes a laminated glass for a vehicle having radio wave-permeability and flying stone-resistance.
Patent Literature 1: WO2019/009336
Patent Literature 2: WO2021/220996

### SUMMARY OF INVENTION

As described above, a glass for a building, for a vehicle, or for a sensor is required to have excellent strength. It is also conceivable to constitute a laminated glass as a means for increasing flying stone-resistance. In the case where a laminated glass is subjected to bending to improve designability, visibility, and the like, for example, it is difficult to produce a laminated glass having a desired shape by simultaneously bending glasses having different thicknesses, and thus excellent formability is required.

In view of the above problems, an object of the present invention is to provide a glass and a laminated glass having excellent strength and formability.

The present inventors have found that the above problems can be solved by using a glass having a specific composition range, and have completed the present invention.

That is, the present invention is as follows.

1. A glass for a building, for a vehicle, or for a sensor, containing, in mol % in terms of oxides:
SiO₂: 60% to 68%;
Al₂O₃: 1.5% to 5.0%;
B₂O₃: 0.0% to 5.0%;
MgO: 0.0% to 10%;
CaO: 10% to 20%;
SrO: 0.0% to 10%;
BaO: 0.0% to 5.0%;
Li₂O: 0.0% to 10%;
Na₂O: 0.0% to 20%;
K₂O: 0.0% to 10%;
Y₂O₃: 0.0% to 1.0%;
total iron oxide in terms of Fe₂O₃: 0.0030% to 0.5%;
SiO₂+Al₂O₃+B₂O₃: 62% to 70%;
R′₂O: 14% to 20%; and
RO: 10% to 20% (where RO represents a total content of MgO, CaO, SrO, and BaO, and R′₂O represents a total content of Li₂O, Na₂O, and K₂O).

2. The glass according to the above 1, having a density of 2.55 g/cm³ or more.

3. The glass according to the above 1, having an average linear expansion coefficient at 50 °C to 350 °C being 95×10⁻⁷/°C or more and 120×10⁻⁷/°C or less.

4. The glass according to the above 1, satisfying K₂O/R′₂O of 0.50 or less.

5. The glass according to the above 1, satisfying
MgO/RO of 0.10 or more and
SrO/RO of 0.10 or more.

6. The glass according to the above 1, which is a bending-formed glass.

7. The glass according to the above 1, which is a physically tempered glass.

8. The glass according to the above 1, having a fictive temperature of (glass transition temperature T_{g}+35) °C or higher and 570 °C or higher and 700 °C or lower.

9 A laminated glass containing:
a first glass plate;
a second glass plate; and
an interlayer sandwiched between the first glass plate and the second glass plate, in which
the first glass plate is the glass according to any one of the above 1 to 8.

10. The laminated glass according to the above 9, in which
an absolute value of difference |T_{A}−T_{B}| is 40 °C or less, where T_{A} and T_{B} represent yield points of the first glass plate and the second glass plate, respectively.

11. The laminated glass according to the above 9, in which
a relationship between a plate thickness t1 of the first glass plate and a plate thickness t2 of the second glass plate is t1≥t2.

12. The laminated glass according to the above 11, in which
the plate thickness t1 of the first glass plate is 2.5 mm or more, and
the plate thickness t2 of the second glass plate is 1.5 mm or less.

13. A vehicular window glass, containing the laminated glass according to the above 9.

14. A window glass for building, containing the laminated glass according to the above 9.

15. A glass for a sensor, containing the laminated glass according to the above 9.

According to the present invention, it is possible to provide a glass for a building, for a vehicle, or for a sensor, a bent glass, an air-cooling-tempered glass, and a laminated glass, which have excellent durability and formability.

### BRIEF DESCRIPTION OF DRAWINGS

FIG. 1 is a cross-sectional view of an example of a laminated glass according to one embodiment of the present invention.

FIG. 2 is a conceptual view illustrating a state where the laminated glass according to one embodiment of the present invention is used as a vehicular window glass.

FIG. 3 is an enlarged view of portion S in FIG. 2.

FIG. 4 is a cross-sectional view taken along line Y-Y in FIG. 3.

### DESCRIPTION OF EMBODIMENTS

Hereinafter, embodiments of the present invention will be described in detail.

In the following drawings, members and portions having the same functions may be denoted by the same reference numerals, and duplicate descriptions may be omitted or simplified. The embodiments described in the drawings are schematic for the purpose of clearly illustrating the present invention, and do not necessarily accurately represent the size or scale of an actual product.

In the present description, a numerical range indicated by using “to” indicates the range including numerical values described before and after “to” as the minimum value and the maximum value, respectively.

Hereinafter, a glass according to the present embodiment is described as an embodiment of a glass for a building, for a vehicle, or for a sensor (hereinafter sometimes simply referred to as a “glass”) according to the present invention.

The glass according to the present embodiment is a glass for a building, for a vehicle, or for a sensor, containing, in mol % in terms of oxides:
SiO₂: 60% to 68%;
Al₂O₃: 1.5% to 5.0%;
B₂O₃: 0.0% to 5.0%;
MgO: 0.0% to 10%;
CaO: 10% to 20%;
SrO: 0.0% to 10%;
BaO: 0.0% to 5.0%;
Li₂O: 0.0% to 10%;
Na₂O: 0.0% to 20%;
K₂O: 0.0% to 10%;
Y₂O₃: 0.0% to 1.0%;
total iron oxide in terms of Fe₂O₃: 0.0030% to 0.5%;
SiO₂+Al₂O₃+B₂O₃: 62% to 70%;
R′₂O: 14% to 20%; and
RO: 10% to 20% (where RO represents a total content of MgO, CaO, SrO, and BaO, and R′₂O represents a total content of Li₂O, Na₂O, and K₂O).

### [Glass Composition]

A composition range of each component is hereinafter be expressed in mol % in terms of oxides unless otherwise specified. In addition, a component “not being substantially contained” means that the component is not contained except for inevitable impurities mixed from raw materials and the like, that is, the component is not intentionally contained.

SiO₂ is a component constituting a network structure of the glass, and is an essential component of the glass according to the present embodiment. In the glass according to the present embodiment, the SiO₂ content is 60% to 68%. In the glass according to the present embodiment, in the case where the SiO₂ content is 60% or more, the density of the glass can be easily reduced, and moisture resistance and chemical durability can be secured. Further, the viscosity of the glass can be decreased. The SiO₂ content is more preferably 61% or more, still more preferably 62% or more, and particularly preferably 63% or more.

In addition, in the glass according to the present embodiment, in the case where the SiO₂ content is 68% or less, an increase in the average linear expansion coefficient is suppressed, an increase in the viscosity during glass melting is prevented, production of the glass is facilitated, and formability for a vehicular glass, particularly a windshield, and a cover glass for sensors, is improved. The SiO₂ content is more preferably 67% or less, still more preferably 66% or less, and particularly preferably 65% or less.

Al₂O₃ is a component constituting the network structure of the glass, and is an essential component of the glass according to the present embodiment. In the glass according to the present embodiment, the Al₂O₃ content is 1.5% to 5.0%. In the glass according to the present embodiment, in the case where the Al₂O₃ content is 1.5% or more, Young's modulus can be increased. In addition, weather resistance, moisture resistance, and chemical durability are improved. In addition, the average linear expansion coefficient is not excessively increased, thermal cracking of the glass can be prevented, and a chemical tempering treatment using ion exchange is possible. The Al₂O₃ content is preferably 1.6% or more, more preferably 1.7% or more, still more preferably 1.8% or more, particularly preferably 1.9% or more, and most preferably 2.0% or more.

In addition, in the glass according to the present embodiment, in the case where the Al₂O₃ content is 5.0% or less, an increase in the viscosity during glass melting is prevented, production of the glass is facilitated, and formability for a vehicular glass, particularly a windshield, and a cover glass for sensors, is improved. The Al₂O₃ content is preferably 4.5% or less, more preferably 4.0% or less, still more preferably 3.5% or less, and particularly preferably 3.0% or less.

B₂O₃ decreases the viscosity and the density of the glass and contributes to an improvement of Young's modulus. It is also a component that increases the density and the thermal expansion coefficient. In the glass according to the present embodiment, the B₂O₃ content is 0.0% to 5.0%.

In the case where B₂O₃ is contained in the glass according to the present embodiment, the viscosity and the density of the glass can be decreased. In the case where B₂O₃ is contained in the glass according to the present embodiment, the content thereof is preferably 0.10% or more, more preferably 0.20% or more, still more preferably 0.30% or more, particularly preferably 0.40% or more, and most preferably 0.50% or more.

In addition, in the glass according to the present embodiment, in the case where the B₂O₃ content is 5.0% or less, an alkali element is less likely to volatilize during melting and forming of the glass, and a decrease in glass quality can be prevented. In addition, acid resistance and alkali resistance can be improved. The B₂O₃ content is preferably 4.0% or less, more preferably 3.0% or less, and still more preferably 2.0% or less.

MgO is a component that decreases the viscosity of the glass and that contributes to an improvement of Young's modulus. It is also a component that increases the density and the thermal expansion coefficient. In the glass according to the present embodiment, the MgO content is 0.0% to 10%.

In the case where MgO is contained in the glass according to the present embodiment, the viscosity of the glass can be decreased and melting of glass raw materials can be promoted. In addition, Young's modulus and moisture resistance can be increased, and the density and the thermal expansion coefficient can be increased. In the case where the glass according to the present embodiment contains MgO, the content thereof is preferably 0.50% or more, more preferably 0.70% or more, still more preferably 1.0% or more, particularly preferably 1.2% or more, and most preferably 1.5% or more.

In addition, in the case where the MgO content is 10% or less in the glass according to the present embodiment, the glass is less likely to undergo devitrification, an excessive increase in viscosity during glass melting is prevented, production of the glass is facilitated, and formability for a vehicular glass, particularly a windshield, and a cover glass for sensors, is improved. The MgO content is preferably 8.0% or less, more preferably 6.0% or less, still more preferably 5.0% or less, particularly preferably 4.0% or less, and most preferably 3.0% or less.

CaO is a component that decreases the viscosity of the glass. It is also a component that increases the density and the thermal expansion coefficient. In the glass according to the present embodiment, the CaO content is 10 to 20%.

In the case where the CaO content in the glass according to the present embodiment is 10% or more, the density and the thermal expansion coefficient of the glass can be improved. In the glass according to the present embodiment, the CaO content is preferably 11% or more, more preferably 12% or more, and particularly preferably 13% or more.

In addition, in the glass according to the present embodiment, by limiting the CaO content to 20% or less, thermal cracking of the glass due to an increase in the average linear expansion coefficient can be suppressed. In the glass according to the present embodiment, the CaO content is preferably 19% or less, more preferably 18% or less, still more preferably 17% or less, particularly preferably 16% or less, and most preferably 15% or less.

SrO is a component that decreases the viscosity of the glass. It is also a component that increases the density and the thermal expansion coefficient. In the glass according to the present embodiment, the SrO content is 0.0% to 10%.

In the case where the glass according to the present embodiment contains SrO, the density and the thermal expansion coefficient of the glass can be improved. In the case where the glass according to the present embodiment contains SrO, the content thereof is preferably 0.50% or more, more preferably 0.70% or more, still more preferably 1.0% or more, particularly preferably 1.2% or more, and most preferably 1.5% or more.

In the glass according to the present embodiment, by limiting the SrO content to 10% or less, an increase in the density of the glass can be prevented. In the glass according to the present embodiment, the SrO content is preferably 9.0% or less, more preferably 8.0% or less, still more preferably 7.0% or less, even more preferably 6.0% or less, particularly preferably 5.0% or less, and most preferably 4.0% or less.

BaO is a component that decreases the viscosity of the glass. In the glass according to the present embodiment, the BaO content is 0.0% to 5.0%.

In the glass according to the present embodiment, by limiting the BaO content to 5.0% or less, an increase in the density of the glass can be prevented. In the glass according to the present embodiment, the BaO content is preferably 4.0% or less, more preferably 3.0% or less, still more preferably 2.0% or less, even more preferably 1.0% or less, and particularly preferably 0.5% or less, and it is most preferable that BaO is not substantially contained. In the glass according to the present embodiment, BaO not being substantially contained means that the BaO content in the glass is 0.10 mol % or less.

In the case where BaO is contained in the glass according to the present embodiment, the BaO content may be 0.20% or more, 0.40% or more, 0.60% or more, 0.80% or more, or 1.0% or more.

In the glass according to the present embodiment, the total content of MgO, CaO, SrO, and BaO (hereinafter sometimes referred to as RO) is 10% to 20%.

In the glass according to the present embodiment, in the case where RO is 10% or more, the density, the thermal expansion coefficient, and Young's modulus of the glass can be improved. RO is preferably 12% or more, more preferably 13% or more, further preferably 14% or more, particularly preferably 15% or more, and most preferably 16% or more.

In the glass according to the present embodiment, by limiting RO to 20% or less, an increase in the density of the glass can be suppressed, and crack resistance of the glass can be improved. Preferably, RO is 19% or less, more preferably 18% or less, and still more preferably 17% or less.

In the glass according to the present embodiment, MgO/RO is preferably 0.10 or more. In the glass according to the present embodiment, in the case where MgO/RO is 0.10 or more, the devitrification temperature can be lowered. MgO/RO is more preferably 0.11 or more, and particularly preferably 0.12 or more.

In the glass according to the present embodiment, the upper limit of MgO/RO is preferably 0.30 or less, more preferably 0.25 or less, still more preferably 0.20 or less, particularly preferably 0.18 or less, and most preferably 0.15 or less, from the viewpoint of suppressing a decrease in the density and the average linear expansion coefficient.

In the glass according to the present embodiment, SrO/RO is preferably 0.10 or more. In the glass according to the present embodiment, in the case where SrO/RO is 0.10 or more, the average linear expansion coefficient can be increased. The SrO/RO is more preferably 0.11 or more, and still more preferably 0.12 or more.

In the glass according to the present embodiment, in order to prevent the average linear expansion coefficient from becoming too large, SrO/RO is preferably 0.30 or less, more preferably 0.25 or less, still more preferably 0.20 or less, particularly preferably 0.18 or less, and most preferably 0.15 or less.

In one aspect of the glass according to the present embodiment, it is preferable that MgO/RO is 0.10 or more and SrO/RO is 0.10 or more. In the case where MgO/RO is 0.10 or more and SrO/RO is 0.10 or more, devitrification of the glass can be suppressed. In such an aspect, MgO/RO is more preferably 0.11 or more and further preferably 0.12 or more, and SrO/RO is more preferably 0.11 or more and further preferably 0.12 or more.

Li₂O is a component that improves solubility of the glass and decreases the viscosity. In addition, it is a component that increases Young's modulus and that contributes to the average linear expansion coefficient of glass. Further, strength of the glass can be increased by performing a chemical tempering treatment by ion exchange with Na ions. In the glass according to the present embodiment, the Li₂O content is 0.0% to 10%.

In the case where Li₂O is contained in the glass according to the present embodiment, the viscosity of the glass can be decreased as compared with Na₂O or K₂O. The Li₂O content is more preferably 0.10% or more, still more preferably 0.20% or more, even more preferably 0.30% or more, particularly preferably 0.40% or more, and most preferably 0.50% or more.

In addition, in the glass according to the present embodiment, in the case where the Li₂O content is 10% or less, thermal cracking of the glass due to an excessively large average linear expansion coefficient can be prevented. In addition, generation of a crystal phase containing Li during production of the glass is prevented, and productivity of the glass is improved. The Li₂O content is preferably 8.0% or less, more preferably 6.0% or less, still more preferably 4.0% or less, particularly preferably 3.0% or less, and most preferably 2.0% or less.

Na₂O is a component that improves solubility of the glass and reduces the viscosity of the glass, and a component that makes it easier to increase Young's modulus and also contributes to the average linear expansion coefficient of the glass. Further, the strength of the glass can be increased by performing a chemical tempering treatment by ion exchange with K ions. In the glass according to the present embodiment, the Na₂O content is 0.0% to 20%.

In the case where Na₂O is contained in the glass according to the present embodiment, the viscosity of the glass can be decreased. In addition, Young's modulus and the average linear expansion coefficient can be increased. The Na₂O content is preferably 5.0% or more, more preferably 10% or more, still more preferably 11% or more, even more preferably 12% or more, even still more preferably 13% or more, particularly preferably 14% or more, and most preferably 15% or more.

In addition, in the glass according to the present embodiment, in the case where the Na₂O content is 20% or less, thermal cracking of the glass due to an excessively large average linear expansion coefficient can be prevented. In addition, since the moisture resistance of the glass is improved, the glass is suitable as a glass to be exposed to the atmosphere for a long period of time, such as a vehicular window glass. The Na₂O content is preferably 19% or less, more preferably 18% or less, still more preferably 17% or less, and particularly preferably 16% or less.

K₂O is a component that improves solubility of the glass and reduces the viscosity of the glass, and a component that makes it easier to increase Young's modulus and also contributes to the average linear expansion coefficient of the glass. In the glass according to the present embodiment, the K₂O content is 0.0% to 10%.

In the case where K₂O is contained in the glass according to the present embodiment, the viscosity of the glass can be decreased. In addition, Young's modulus and the average linear expansion coefficient can be increased. In the case where K₂O is contained, the content thereof is preferably 0.10% or more, more preferably 0.20% or more, still more preferably 0.30% or more, particularly preferably 0.40% or more, and most preferably 0.50% or more.

On the other hand, K₂O has an effect of increasing the average linear expansion coefficient and the density as compared with Li₂O and Na₂O. In the glass according to the present embodiment, in the case where the K₂O content is 10% or less, thermal cracking of the glass due to an excessively large average linear expansion coefficient can be prevented. The K₂O content is preferably 8.0% or less, more preferably 6.0% or less, still more preferably 5.0% or less, even more preferably 4.0% or less, particularly preferably 3.0% or less, and most preferably 2.0% or less.

In the glass according to the present embodiment, the total content of Li₂O, Na₂O, and K₂O (hereinafter sometimes referred to as R′₂O) is 14 to 20%.

In the glass according to the present embodiment, in the case where the R′₂O is 14% or more, Young's modulus increases and the viscosity of the glass decreases, so that formability is improved. R′₂O is preferably 15% or more, and particularly preferably 16% or more.

In addition, in the glass according to the present embodiment, in the case where R′₂O is 20% or less, an increase in the density can be suppressed, and moisture resistance of the glass can be further improved. R′₂O is preferably 19% or less, more preferably 18% or less, and most preferably 17% or less.

In the glass according to the present embodiment, K₂O/R′₂O is preferably 0.50 or less. In the glass according to the present embodiment, in the case where K₂O/R′₂O is 0.50 or less, a decrease in Young's modulus or rigidity modulus can be suppressed, and sufficient strength can be secured. The K₂O/R′₂O is more preferably 0.40 or less, further preferably 0.30 or less, particularly preferably 0.20 or less, and most preferably 0.15 or less.

In the glass according to the present embodiment, the lower limit of K₂O/R′₂O is not particularly limited, and is preferably, for example, 0.01 or more.

Fe₂O₃ is a component that improves heat-shielding property of the glass and is a component that also contributes to color tone of the glass. In the glass according to the present embodiment, the content of the total iron oxide in terms of Fe₂O₃ is 0.0030 to 0.50%. Note that, the content of the total iron oxide in terms of Fe₂O₃ here refers to the total amount of iron including FeO, which is an oxide of divalent iron, and Fe₂O₃, which is an oxide of trivalent iron.

In the glass according to the present embodiment, in the case where the content of the total iron oxide in terms of Fe₂O₃ is 0.0030% or more, heat-shielding property can be improved, designability can be imparted, and heat can be more readily transferred to the glass during glass bending, thereby improving formability. In addition, in the glass according to the present embodiment, by limiting the content of the total iron oxide in terms of Fe₂O₃ to 0.50% or less, a decrease in light transmittance in the visible region can be prevented.

In the case where the glass according to the present embodiment is used for a window glass for building, the content of the total iron oxide in terms of Fe₂O₃ is preferably 0.010% or more, more preferably 0.020% or more, particularly preferably 0.030% or more, and most preferably 0.040% or more, from the viewpoint of improving heat-shielding property and imparting designability.

In addition, in the case where the glass according to the present embodiment is used as a window glass for building, the content of the total iron oxide in terms of Fe₂O₃ is preferably 0.40% or less, more preferably 0.30% or less, still more preferably 0.25% or less, particularly preferably 0.20% or less, and most preferably 0.10% or less, from the viewpoint of further preventing a decrease in light transmittance in the visible region.

In the case where the glass according to the present embodiment is used as a vehicular window glass, the content of the total iron oxide in terms of Fe₂O₃ is preferably 0.020% or more, more preferably 0.040% or more, still more preferably 0.080% or more, even more preferably 0.12% or more, particularly preferably 0.16% or more, and most preferably 0.18% or more, from the viewpoint of improving heat-shielding property, imparting designability, and facilitating heat transfer to the glass during glass bending.

In addition, in the case where the glass according to the present embodiment is used as a vehicular window glass, the content of the total iron oxide in terms of Fe₂O₃ is preferably 0.45% or less, more preferably 0.40% or less, still more preferably 0.35% or less, particularly preferably 0.30% or less, and most preferably 0.25% or less, from the viewpoint of further preventing a decrease in light transmittance in the visible region.

In the case where the glass according to the present embodiment is used as a sensor glass (for example, a cover glass for a LiDAR or a camera), the content of the total iron in terms of Fe₂O₃ is preferably 0.0030% or more, and more preferably 0.0032% or more, 0.0034% or more, or 0.0036% or more in this order, still more preferably 0.0038% or more, particularly preferably 0.0040% or more, and most preferably 0.0042% or more, from the viewpoint of facilitating melting of the raw materials during glass production and from the viewpoint of reducing the amount of an expensive high purity raw material to be used.

In addition, the content of the total iron oxide in terms of Fe₂O₃ is more preferably 0.020% or less, still more preferably 0.010% or less, even more preferably 0.0080% or less, particularly preferably 0.0070% or less, and most preferably 0.0060% or less, from the viewpoint of preventing a decrease in light transmittance in the visible region or the near-infrared region.

In the glass according to the present embodiment, the mass ratio (%) of divalent iron in terms of Fe₂O₃ in the total iron in terms of Fe₂O₃ (hereinafter referred to as Fe-Redox) is preferably 15% or more. The Fe-Redox value is a ratio of the Fe²⁺ content in terms of Fe₂O₃ to the content of the total iron in terms of Fe₂O₃. In the case where Fe-Redox is 15% or more, the Fe²⁺ content having an absorption in the near-infrared region can be increased, and thus heat can be more readily transferred to the molten glass during glass production, so that productivity is improved. In addition, since the transmittance in the near-infrared region decreases and heat-shielding property can be improved, the glass becomes suitable for applications requiring heat-shielding property, such as a window glass for building or vehicular window glass.

In the case where the glass according to the present embodiment is used as a window glass for building or vehicular window glass, Fe-Redox is more preferably 20% or more, still more preferably 22% or more, particularly preferably 24% or more, and is preferably 50% or less. In the case where Fe-Redox is 50% or less, deterioration of a melting facility can be prevented, and in addition, in the case where SO₃ is used as a fining agent, amber coloring can be prevented and a decrease in visible light transmittance can be prevented. Fe-Redox is more preferably 45% or less, still more preferably 40% or less, and particularly preferably 38% or less.

In the case where the glass according to the present embodiment is used as a sensor glass, Fe-Redox is more preferably 16% or more, still more preferably 17% or more, and particularly preferably 18% or more, and is preferably 35% or less. In the case where Fe-Redox is 35% or less, a decrease in transmittance in the near-infrared region can be prevented. Fe-Redox is more preferably 32% or less, still more preferably 30% or less, and particularly preferably 28% or less.

Fe-Redox can be adjusted based on a raw material composition, melting temperature, and melting atmosphere. In addition, Fe-Redox can be adjusted by controlling the oxidation-reduction degree of the molten glass by using a reducing agent such as coke or ammonium chloride as a raw material.

### [Other Components]

The glass according to the present embodiment may contain components other than the above components (hereinafter, also referred to as “other components”). Examples of the other components include TiO₂, ZrO₂, Y₂O₃, CeO₂, Nd₂O₅, GaO₂, GeO₂, MnO₂, NiO, Cr₂O₃, V₂O₅, Au₂O₃, Ag₂O, CuO, CdO, MoO₃, SO₃, Cl, F, SnO₂, and Sb₂O₃, and the other components may be metal ions or oxides.

The other components may be contained in an amount of preferably, for example, 3.0% or less in total for various purposes (for example, fining, coloring, or imparting chemical durability). In the case where the total content of the other components is 3.0% or less, the glass can maintain properties necessary for a glass for a building, for a vehicular, or for a sensor. The total content of the other components is more preferably 2.5% or less, still more preferably 2.0% or less, even more preferably 1.5% or less, especially preferably 1.0% or less, particularly preferably 0.80% or less, and most preferably 0.50% or less. In order to prevent adverse influences on the environment, the contents of As₂O₃ and PbO are each preferably less than 0.0010%, and it is more preferable that they are not substantially contained.

The glass according to the present embodiment may contain ZrO₂. ZrO₂ is a component that improves chemical durability. In the case where the glass according to the present embodiment contains ZrO₂, the content thereof is preferably 0.010% or more, more preferably 0.050% or more, still more preferably 0.10% or more, and particularly preferably 0.20% or more. In addition, the ZrO₂ content is preferably 2.0% or less, more preferably 1.5% or less, still more preferably 1.0% or less, and particularly preferably 0.50% or less, from the viewpoint of preventing an increase in the density and the viscosity of the glass.

The glass according to the present embodiment may contain Y₂O₃. Y₂O₃ is a component that increases Young's modulus. In the case where the glass according to the present embodiment contains Y₂O₃, the content thereof is preferably 0.10% or more, more preferably 0.20% or more, still more preferably 0.30% or more, and particularly preferably 0.40% or more. In addition, the Y₂O₃ content is preferably 2.0% or less, more preferably 1.5% or less, still more preferably 1.0% or less, and particularly preferably 0.80% or less, from the viewpoint of preventing an increase in the density and the viscosity of the glass.

In the case where the glass according to the present embodiment contains NIO, NiS may be formed to cause glass breakage, and thus the NiO content is preferably 0.0080% or less. The NiO content in the glass according to the present embodiment is more preferably 0.0040% or less, still more preferably 0.0020% or less, and it is particularly preferable that it is not substantially contained.

The glass according to the present embodiment may contain CeO₂. CeO₂ has an absorption in the ultraviolet region, and thus reduces the ultraviolet transmittance Tuv and improves UV cut performance. In addition, CeO₂ can act as an oxidizing agent to control Fe-Redox. In the case where the glass according to the present embodiment contains CeO₂, the content thereof is preferably 0.010% or more, more preferably 0.020% or more, still more preferably 0.040% or more, and particularly preferably 0.070% or more. CeO₂ absorbs light in the ultraviolet region to cause solarization, and the transmittance in the visible region may be reduced. Therefore, the CeO₂ content is preferably 0.25% or less, more preferably 0.18% or less, still more preferably 0.14% or less, and particularly preferably 0.10% or less.

The glass according to the present embodiment may contain Cr₂O₃. Cr₂O₃ can act as an oxidizing agent to control Fe-Redox. In the case where the glass according to the present embodiment contains Cr₂O₃, the content thereof is preferably 0.0020% or more, and more preferably 0.0040% or more. Since Cr₂O₃ causes coloration under light in the visible region, the visible light transmittance may be reduced. In addition, the amount of Fe²⁺ may be reduced, and heat-shielding property may decrease. Therefore, in the case where the glass according to the present embodiment contains Cr₂O₃, the content thereof is preferably 0.020% or less, more preferably 0.016% or less, still more preferably 0.012% or less, and particularly preferably 0.0080% or less.

The glass according to the present embodiment may contain SnO₂. SnO₂ can act as a reducing agent to control Fe-Redox. In the case where the glass according to the present embodiment contains SnO₂, the content thereof is preferably 0.010% or more, more preferably 0.040% or more, still more preferably 0.060% or more, and particularly preferably 0.080% or more. On the other hand, in order to prevent defects derived from SnO₂ during glass production, the SnO₂ content in the glass according to the present embodiment is preferably 0.40% or less, more preferably 0.30% or less, still more preferably 0.20% or less, and particularly preferably 0.15% or less.

The glass according to the present embodiment may contain SO₃. SO₃ acts as a fining agent and therefore improves bubble quality of the glass. In the case where the glass according to the present embodiment contains SO₃, the content thereof is preferably 0.0010% or more, more preferably 0.0040% or more, still more preferably 0.0070% or more, and particularly preferably 0.015% or more. In the case where the glass has a large Fe-Redox, SO₃ may promote amber coloring, resulting in browning of the glass and reduction of the visible light transmittance. In the case where the glass according to the present embodiment contains SO₃, the content thereof is preferably 0.070% or less, more preferably 0.060% or less, still more preferably 0.050% or less, and particularly preferably 0.040% or less.

The glass according to the present embodiment may contain Cl. Cl acts as a fining agent and therefore improves bubble quality of the glass. In the case where the glass according to the present embodiment contains Cl, the content thereof is preferably 0.080% or more, more preferably 0.15% or more, still more preferably 0.20% or more, particularly preferably 0.25% or more, and most preferably 0.30% or more. In the case where the Cl content is large, Cl₂ gas volatilized from the molten glass may corrode surrounding members. In the case where glass according to the present embodiment contains Cl, the content thereof is preferably 1.0% or less, more preferably 0.80% or less, still more preferably 0.60% or less, and particularly preferably 0.50% or less.

### Properties

### (T₂)

In the glass according to the present embodiment, the temperature T₂ at which the glass viscosity η reaches 10² [dPa·s], which serves as an index of the solubility of the glass, is preferably 1250 °C or higher and 1450 °C or lower.

In the glass according to the present embodiment, in the case where T₂ is 1450 °C or lower, consumption of fuel used during melting of the glass raw material can be reduced, and the lifetime of a brick member used in the melting furnace can be extended. T₂ is more preferably 1425 °C or lower, still more preferably 1400 °C or lower, even more preferably 1380 °C or lower, particularly preferably 1360 °C or lower, and most preferably 1350 °C or lower. Examples of the method of adjusting T₂ to 1450 °C or lower include a method of increasing the content of R′₂O and RO, and reducing the Al₂O₃ content, a method of incorporating Li₂O among the R′₂O, a method of reducing the SiO₂ content, and a method of adjusting the B₂O₃ content, in the glass components.

In the glass according to the present embodiment, in the case where T₂ is 1250 °C or more, it is possible to suppress a decrease in weather resistance and chemical durability of the glass. T₂ is preferably 1260 °C or higher, more preferably 1270 °C or higher, still more preferably 1280 °C or higher, particularly preferably 1290 °C or higher, and most preferably 1300 °C or higher.

### (T₄)

In the glass according to the present embodiment, the temperature T₄ at which the glass viscosity η reaches 10⁴ [dPa·s], which serves as an index of the formability during float forming, is preferably 900 °C or higher and 1200 °C or lower.

In the glass according to the present embodiment, in the case where T₄ is 1200 °C or less, it is suitable for plate forming by a float method. T₄ is more preferably 1180 °C or lower, still more preferably 1170 °C or lower, even more preferably 1160 °C or lower, particularly preferably 1150 °C or lower, and most preferably 1140 °C or lower.

Examples of the method of adjusting T₄ to 1200 °C or lower include a method of increasing the content of R′₂O and RO, and reducing the Al₂O₃ content, a method of incorporating Li₂O among the R′₂O, a method of reducing the SiO₂ content, and a method of adjusting the B₂O₃ contentin the glass components.

In the glass according to the present embodiment, in the case where T₄ is 900 °C or more, it is possible to suppress a decrease in weather resistance and chemical durability of the glass. T₄ is more preferably 920 °C or higher, further preferably 940 °C or higher, particularly preferably 960 °C or higher, and most preferably 980 °C or higher.

### (T_{L})

The glass according to the present embodiment preferably has a liquidus temperature T_{L} of 800 °C or higher and 1200 °C or lower.

In the glass according to the present embodiment, in the case where T_{L} is 1200 °C or less, occurrence of devitrification during glass melting can be prevented. T_{L} is more preferably 1175 °C or lower, still more preferably 1150 °C or lower, even more preferably 1125 °C or lower, particularly preferably 1100 °C or lower, and most preferably 1080 °C or lower.

Examples of the method of adjusting T_{L} to 1200 °C or lower include a method of adjusting the contents of R′₂O and RO and a method of increasing the ratio of MgO or SrO among RO, in the glass components.

In the glass according to the present embodiment, the lower limit of T_{L} is not particularly limited, and is, for example, 800 °C or higher.

### (T_{g})

The glass according to the present embodiment preferably has a glass transition temperature (T_{g}) in a range of 500 °C to 580 °C. In the case where T_{g} is within this predetermined temperature range, the glass can be bent within general production condition ranges. In the case where T_{g} of the glass according to the present embodiment is 500 °C or higher, the alkali metal content or the alkaline earth metal content is not too large, an excessive increase in the average linear expansion coefficient of the glass can be prevented, and weather resistance and chemical durability of the glass can be increased. In addition, devitrification of the glass can be prevented, and formability can be improved. T_{g} is more preferably 510 °C or higher, still more preferably 520 °C or higher, and particularly preferably 530 °C or higher.

In addition, T_{g} is preferably 575 °C or lower, more preferably 570 °C or lower, still more preferably 565 °C or lower, particularly preferably 560 °C or lower, and most preferably 555 °C or lower, from the viewpoint of preventing a bending temperature of the glass from being excessively high to facilitate the production.

### (Fictive Temperature T_{f})

It is preferable that the fictive temperature T_{f} of the glass according to the present embodiment is (glass transition temperature T_{g}+35) °C or more and 570 °C or higher and 700 °C or lower. In the case where the fictive temperature Tris within this predetermined temperature range, the strength of the glass can be increased while maintaining bending formability.

The fictive temperature Tr of the glass according to the present embodiment is preferably (glass transition temperature T_{g}+35) °C or higher, more preferably (glass transition temperature T_{g}+38) °C or higher, further preferably (glass transition temperature T_{g}+40) °C or higher, particularly preferably (glass transition temperature T_{g}+42) °C or higher, and most preferably (glass transition temperature T_{g}+44) ° °C or higher. In addition, in the glass according to the present embodiment, the fictive temperature Tris preferably 570 °C or higher, more preferably 575 °C or higher, still more preferably 580 °C or higher, still more preferably 585 °C or higher, and particularly preferably 590 °C or higher. In the glass according to the present embodiment, the fictive temperature Tris more preferably 700 °C or lower, still more preferably 680 °C or lower, even more preferably 660 °C or lower, even still more preferably 650 °C or lower, particularly preferably 640 °C or lower, and most preferably 630 °C or lower.

The fictive temperature can be measured by a known method.

More specifically, the fictive temperature T_{f} can be determined by the following procedures 1) to 3).

1) First, i (i≥2) test pieces are prepared from a glass sample whose fictive temperature is to be measured, held at different cooling-start temperatures until the refractive index reaches an equilibrium state, and then cooled at a cooling rate of 1000 °C/min or more. Here, in the case where the cooling-start temperature is lower than the glass transition temperature, a sufficiently long holding time is required, and thus the cooling-start temperature is preferably set to a temperature higher than the glass transition temperature by 10 °C to 200 °C. 2) The refractive index n_{d} of the glass cooled under the conditions described in 1) is measured at a specific wavelength (for example, the d-line of a He lamp, 587.6 nm). For each cooling-start temperature Tᵢ, the refractive index n_{di} of the glass quenched from the cooling-start temperature is plotted to create a calibration curve. 3) Next, a test piece is cut out from the glass whose fictive temperature Tris to be measured, the refractive index n_{d} of the polished test piece is measured, and the fictive temperature T_{f} of the glass is determined by using the calibration curve.

### (Yield Point)

The glass according to the present embodiment preferably has a yield point of 570 °C or higher and 670 °C or lower.

In the glass according to the present embodiment, in the case where the yield point is 570 °C or higher, the average linear expansion coefficient of the glass is prevented from becoming too large, weather resistance and chemical durability of the glass can be enhanced, and the glass has excellent manufacturability. The yielding point is more preferably 575 °C or higher, further preferably 580 °C or higher, particularly preferably 585 °C or higher, and most preferably 590 °C or higher.

In the glass according to the present embodiment, in the case where the yield point is 670 °C or less, the glass is excellent in bending formability, and is excellent in device load and shape stability during bending. The yield point is more preferably 665 °C or lower, still more preferably 660 °C or lower, still more preferably 655 °C or lower, particularly preferably 650 °C or lower, and most preferably 645 °C or lower.

### (Average Linear Expansion Coefficient)

The glass according to the present embodiment preferably has an average linear expansion coefficient (CTE) of 95×10⁻⁷/°C or more and 120× 10⁻⁷/°C or less at 50 °C to 350 °C.

In the case where the average linear expansion coefficient is 120×10⁻⁷/°C or less, cracking due to heat shock can be prevented in the case where the glass according to the present embodiment is used as a glass for a vehicle, for a building, or for a sensor. In addition, in the case where the glass according to the present embodiment is a bent glass, a difference in thermal expansion due to a difference in in-plane thermal history can be prevented, and a bent glass having a good dimension and surface accuracy can be obtained.

The average linear expansion coefficient of the glass according to the present embodiment at 50 °C to 350 °C is preferably 118×10⁻⁷/°C or less, more preferably 116×10⁻⁷/°C or less, still more preferably 114×10⁻⁷/°C or less, particularly preferably 112×10⁻⁷/°C or less, and most preferably 110×10⁻⁷/°C or less.

In addition, the glass according to the present embodiment preferably has an average linear expansion coefficient of 95×10⁻⁷/°C or more, from the viewpoint of, for example, preventing cracking of a black ceramic due to a difference in thermal expansion from the black ceramic to be printed on a windshield. In the case where the average linear expansion coefficient is 95×10⁻⁷/°C or more, the difference in thermal expansion from the black ceramic is small, and the cracking of the black ceramic can be prevented. Further, the adhesion to a mold during bending is improved, and bending formability is improved. The average linear expansion coefficient is more preferably 96×10⁻⁷/°C or more, still more preferably 98×10⁻⁷/°C or more, particularly preferably 100×10⁻⁷/°C or more, particularly preferably 10²×10⁻⁷/°C or more, particularly preferably 10⁴×10⁻⁷/°C or more, and most preferably 106×10⁻⁷/°C or more.

In order to adjust the average linear expansion coefficient within the above range, a method of increasing the SiO₂ content in the glass components and adjusting the contents of R′₂O, RO, and Al₂O₃, the B₂O₃ content, and the coordination number of boron is exemplified.

### (Density)

The glass according to the present embodiment preferably has a density of 2.55 g/cm³ or higher and 2.75 g/cm³ or lower.

In the glass according to the present embodiment, in the case where the density is 2.55 g/cm³ or higher, the glass is easily bent by its own weight at the time of bending, and bending formability is improved. The density is more preferably 2.57 g/cm³ or higher, further preferably 2.60 g/cm³ or higher, particularly preferably 2.61 g/cm³ or higher, and most preferably 2.62 g/cm³ or higher.

In the glass according to the present embodiment, in the case where the density is 2.75 g/cm³ or lower, an increase in the weight of the glass is suppressed, and it is possible to prevent an increase in fuel consumption and electric power consumption. The density is more preferably 2.73 g/cm³ or lower, further preferably 2.70 g/cm³ or lower, still preferably 2.69 g/cm³ or lower, particularly preferably 2.68 g/cm³ or lower, and most preferably 2.66 g/cm³ or lower. The density was measured by Archimedes' method.

### (Young's Modulus)

The glass according to the present embodiment preferably has a Young's modulus of 74 GPa or more. In the case where Young's modulus is 74 GPa or more, the glass has high rigidity and the fracture toughness value is increased, and thus the glass is more suitable as a window glass for a vehicle or for a building or a cover glass for a sensor such as a LiDAR. Young's modulus of the glass according to the present embodiment is preferably 75 GPa or more, more preferably 76 GPa or more, particularly preferably 77 GPa or more, and most preferably 78 GPa or more.

In addition, Young's modulus is preferably 85 GPa or less, more preferably 83 GPa or less, still more preferably 82 GPa or less, particularly preferably 81 GPa or less, and most preferably 80 GPa or less, from the viewpoint of preventing deformation and cracking of the glass when receiving an external force.

Examples of the method for adjusting Young's modulus within the above range include increasing the proportion of the four-coordinated boron, and adjusting the kinds and the amounts of RO and R′₂O.

Young's modulus can be measured by using an ultrasonic pulse method based on JIS R1602:1995 “Testing methods for elastic modulus of fine ceramics”.

### (Rigidity Modulus)

The glass according to the present embodiment preferably has a rigidity modulus of 27 GPa or more. In the case where the rigidity modulus is 27 GPa or more, the glass is less likely to be deformed when receiving an external force. The rigidity modulus of the glass is preferably 28 GPa or more, more preferably 29 GPa or more, particularly preferably 30 GPa or more, and most preferably 31 GPa or more.

In addition, the rigidity modulus is preferably 38 GPa or less, more preferably 35 GPa or less, still more preferably 34 GPa or less, and particularly preferably 33 GPa or less, since cracking can be prevented by deforming the glass to consume the energy when receiving an external force.

The rigidity modulus can be measured by using an ultrasonic pulse method based on JIS R1602:1995 “Testing methods for elastic modulus of fine ceramics”.

### (Poisson's Ratio)

The glass according to the present embodiment preferably has a Poisson's ratio of 0.28 or less. The smaller the Poisson's ratio, the smaller the stress generated when the glass receives an external force. The Poisson's ratio is more preferably 0.27 or less, still more preferably 0.26 or less, particularly preferably 0.25 or less, and most preferably 0.24 or less.

The Poisson's ratio can be measured by using an ultrasonic pulse method based on JIS R1602:1995 “Testing methods for elastic modulus of fine ceramics”.

### (Fracture Toughness Value K_{IC})

The glass according to the present embodiment preferably has a fracture toughness value K_{IC} of 0.76 MPa·m^{1/2} or more, measured by a double cleavage drilled compression (DCDC) method. The fracture toughness value K_{IC} serves as an index of the strength of the glass, and the larger the fracture toughness value K_{IC} is, the more difficult the crack progresses and the higher the cracking resistance is. Therefore, in the case where the fracture toughness value K_{IC} is 0.76 MPa·m^{1/2} or more, sufficient cracking resistance is achieved, which is suitable for a window glass for vehicles or buildings or a cover glass for sensors. The fracture toughness value K_{IC} is more preferably 0.77 MPa·m¹² or more, still more preferably 0.78 MPa·m¹² or more, still more preferably 0.79 MPa·m^{1/2} or more, and most preferably 0.80 MPa·m^{1/2} or more. The upper limit of the fracture toughness value K_{IC} is not particularly limited, and is, for example, 0.90 MPa·m^{1/2} or less.

The fracture toughness value K_{IC} is measured by using the DCDC method.

Examples of the method of adjusting the fracture toughness value within the above range include increasing the SiO₂ content, increasing the ratio of an alkaline earth metal component having a small atomic number among RO, and increasing the ratio of R₂′O, in particular, an alkali metal component having a small atomic number among R₂′O. Specifically, since SiO₂ and B₂O₃ (especially four-coordinate boron) are components that form a network structure, the structure of the glass becomes strong by increasing these contents, and thus the fracture toughness value can be increased. In addition, as the atomic number of the alkaline earth metal component is smaller in RO, Young's modulus is increased, and as a result, the fracture toughness value can be increased. As the atomic number of the alkali metal component is smaller in R′₂O, a similar tendency to RO is shown.

### (Area of Main Surface)

In the case where the glass according to the present embodiment is used as a vehicular window glass, the shape of the glass according to the present embodiment is not particularly limited. The area of the main surface is preferably 0.25 m² or more, more preferably 0.45 m² or more, and still more preferably 0.90 m² or more. In the case where the area of the glass is within the above range, the glass can be suitable for various vehicle types. In addition, in the case where the area of the glass is too large, difficulty of the bending forming increases, such as difficulty in handling, non-uniformity of temperature distribution during heating, and deterioration of dimensional accuracy after the bending forming. Therefore, the area of the main surface of the glass according to the present embodiment is preferably 10 m² or less, more preferably 7 m² or less, and still more preferably 5 m² or less.

In the case where the glass according to the present embodiment is used as a window glass for building, the shape of the glass according to the present embodiment is not particularly limited. The area of the main surface is preferably 0.04 m² or more, more preferably 0.09 m² or more, still more preferably 0.25 m² or more, particularly preferably 0.45 m² or more. In the case where the area of the glass is within the above range, the window glass can be suitable for various types. In addition, in the case where the area of the glass is too large, difficulty of the bending forming increases, such as difficulty in handling, non-uniformity of temperature distribution during heating, and deterioration of dimensional accuracy after the bending forming. Therefore, the area of the main surface of the glass according to the present embodiment is preferably 10 m² or less, more preferably 7 m² or less, and still more preferably 5 m² or less.

In the case where the glass according to the present embodiment is used as a cover glass for a LiDAR, the glass according to the present embodiment preferably has a high transmittance at a wavelength of 905 nm or 1550 nm used in the LiDAR. Therefore, in the glass according to the present embodiment, the transmittance at a wavelength of 905 nm or 1550 nm in terms of a thickness of 4.0 mm is preferably 86% or more, more preferably 87% or more, still more preferably 88% or more, even more preferably 89% or more, particularly preferably 90% or more, and most preferably 91% or more.

In the case where the glass according to the present embodiment is used as a cover glass for sensors, the shape of the glass according to the present embodiment is not particularly limited. The area of the main surface is preferably 0.00010 m² or more, more preferably 0.010 m² or more, still more preferably 0.020 m² or more, particularly preferably 0.040 m² or more, and most preferably 0.090 m² or more. In the case where the area of the glass is within the above range, it is possible to cope with cover glasses for various LiDARs. In addition, in the case where the area of the glass is too large, difficulty of the bending forming increases, such as non-uniformity of temperature distribution during heating, and deterioration of dimensional accuracy after the bending forming. Therefore, the area of the main surface of the glass according to the present embodiment is preferably 1.0 m² or less, more preferably 0.90 m² or less, and still more preferably 0.80 m² or less.

### (Thickness)

The glass according to the present embodiment preferably has a thickness of 2.5 mm or more. In the case where the thickness of the glass is 2.5 mm or more, the strength can be improved. The thickness of the glass is more preferably 2.8 mm or more, still more preferably 2.9 mm or more, even more preferably 3.0 mm or more, even still more preferably 3.1 mm or more, yet more preferably 3.2 mm or more, yet still more preferably 3.3 mm or more, particularly preferably 3.4 mm or more, and most preferably 3.5 mm or more.

In addition, the thickness of the glass according to the present embodiment is preferably 5.0 mm or less, more preferably 4.8 mm or less, still more preferably 4.5 mm or less, particularly preferably 4.2 mm or less, and most preferably 4.0 mm or less, from the viewpoint of preventing an increase in fuel consumption and electric power consumption due to an increase in weight of the glass.

Note that, examples of the method of adjusting the thickness of the glass include a method of adjusting the thickness of the glass by using a float method or a down draw method, to be described later, and a method of polishing the glass in a thickness direction by using a grindstone and then performing mirror-finishing by using an abrasive such as cerium oxide. The surface roughness Ra after forming or polishing is preferably 5.0 nm or less, more preferably 2.0 nm or less, still more preferably 1.5 nm or less, particularly preferably 1.0 nm or less, and most preferably 0.50 nm or less.

### Manufacturing Method

Examples of the method for producing the glass according to the present embodiment include known forming methods such as a float method, a roll-out method, and a down draw method. The glass according to the present embodiment may be a physically tempered glass. The physically tempered glass is the glass that has been subjected to a physical tempering treatment, and the strength of the glass can be increased by performing the treatment.

Here, the physical tempering is a treatment of forming a compressive stress layer on the surface of the glass by a thermal tempering treatment. Specifically, a uniformly heated glass is rapidly cooled from a temperature near the softening point to generate a compressive stress on the surface of the glass due to a temperature difference between the surface and the inside of the glass. The compressive stress is generated uniformly over the entire surface of the glass, and a compressive stress layer having a uniform depth is formed over the entire surface of the glass. The thermal tempering treatment is more suitable for tempering a glass having a thick plate thickness than a chemical tempering treatment.

The glass according to the present embodiment may be a bent glass. The bent glass is glass obtained by bending glass. Examples of the method for forming the bent glass include gravity-forming and press-forming.

The bent glass according to the present embodiment is a glass that curves with a predetermined curvature, may be a single-bent glass that curves only in one direction, either an up-and-down direction or a right-and-left direction, or may be a multi-bent glass that curves both in the up-and-down direction and the right-and-left direction.

### <Laminated Glass>

A laminated glass according to the present embodiment includes a first glass plate, a second glass plate, and an interlayer sandwiched between the first glass plate and the second glass plate, and the first glass plate is the glass according to the present embodiment.

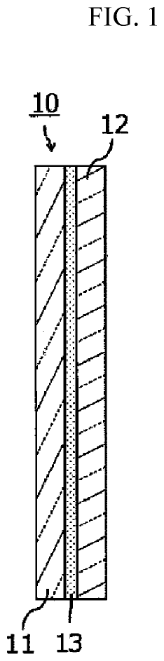

FIG. 1 is a view illustrating an example of a laminated glass 10 according to the present embodiment. The laminated glass 10 includes a first glass plate 11, a second glass plate 12, and an interlayer 13 sandwiched between the first glass plate 11 and the second glass plate 12. Note that, the laminated glass 10 according to the present embodiment is not limited to the aspect in FIG. 1, and can be modified without departing from the gist of the present invention. For example, the interlayer 13 may be formed as one layer as illustrated in FIG. 1, or may be formed as two or more layers. In addition, the laminated glass 10 according to the present embodiment may include three or more glass plates, and in this case, an organic resin or the like may be interposed between adjacent glass plates. Hereinafter, the laminated glass 10 according to the present embodiment will be described as a configuration in which only two glass plates, that is, the first glass plate 11 and the second glass plate 12, are included, and the interlayer 13 is sandwiched therebetween.

In the laminated glass according to the present embodiment, the first glass plate 11 is the glass according to the present embodiment from the viewpoint of bending formability. In the case where the first glass plate 11 and the second glass plate 12 are each the glass according to the present embodiment, glass plates having the same composition or glass plates having different compositions may be used as the first glass plate 11 and the second glass plate 12.

In the laminated glass according to the present embodiment, in the case where the first glass plate 11 or the second glass plate 12 is not the glass according to the present embodiment, the kind of the glass plate is not particularly limited, and a known glass plate used for a vehicular window glass or the like can be used. Specific examples thereof include an alkali aluminosilicate glass, an alkali aluminoborosilicate glass, and a soda lime glass. These glass plates may be colored to such an extent that the transparency thereof is not impaired, or may not be colored.

In the laminated glass of the present embodiment, the absolute value |T_{A}−T_{B}| of the difference when the yield point (°C) of each of the first glass plate 11 and the second glass plate 12 is denoted as T_{A} and T_{B}, respectively, is preferably 40 °C or less, more preferably 35 °C or less, further preferably 30 °C or less, still further preferably 20 °C or less, still more preferably 15 °C or less, particularly preferably 10 °C or less, and most preferably 5 °C or less. In the case where |T_{A}−T_{B}| is 40 °C or less, the difference in the yield point is set to a certain temperature or less, and formability can be further improved. The lower limit of |T_{A}−T_{B}| is not particularly limited, and is, for example, 0 °C or more.

The thickness of the first glass plate 11 is preferably 2.5 mm or more. In the case where the thickness of the first glass plate 11 is 2.5 mm or more, durability of the laminated glass can be improved. The thickness of the first glass plate 11 is more preferably 2.6 mm or more, still more preferably 2.7 mm or more, even more preferably 2.8 mm or more, even still more preferably 2.9 mm or more, yet more preferably 3.0 mm or more, yet still more preferably 3.1 mm or more, particularly preferably 3.2 mm or more, and most preferably 3.3 mm or more. In addition, the thickness of the first glass plate 11 is preferably 5.0 mm or less, more preferably 4.8 mm or less, still more preferably 4.6 mm or less, particularly preferably 4.4 mm or less, and most preferably 4.2 mm or less, from the viewpoint of preventing an increase in fuel consumption and electric power consumption due to an increase in weight of the glass.

The thickness of the second glass plate 12 is preferably 0.30 mm or more, more preferably 0.40 mm or more, still more preferably 0.50 mm or more, particularly preferably 0.60 mm or more, particularly preferably 0.70 mm or more, and most preferably 0.80 mm or more. The thickness of the second glass plate 12 is preferably 0.30 mm or more from the viewpoint of impact resistance.

In addition, the thickness of the second glass plate 12 is preferably 1.5 mm or less, more preferably 1.4 mm or less, still more preferably 1.3 mm or less, particularly preferably 1.2 mm or less, particularly preferably 1.1 mm or less, and most preferably 1.0 mm or less. In the case where the thickness of the second glass plate 12 is 1.5 mm or less, the weight of the laminated glass 10 is not too large, which is preferred from the viewpoint of improving fuel efficiency in the case of being used for a vehicle.

The first glass plate 11 and the second glass plate 12 may have the same thickness or different thicknesses, but the first glass plate 11 is preferably thicker than the second glass plate 12. That is, the relationship between the plate thickness t1 of the first glass plate 11 and the plate thickness t2 of the second glass plate 12 is preferably t1≥t2, and more preferably t1>t2. Examples of the method of adjusting the thickness of the first glass plate 11 and the second glass plate 12 include a method of adjusting the thickness of the glass by using a float method or a down draw method, and a method of polishing the glass in a thickness direction by using a grindstone and then performing mirror-finishing using an abrasive such as cerium oxide. The surface roughness Ra after forming or polishing is preferably 5.0 nm or less, more preferably 2.0 nm or less, still more preferably 1.5 nm or less, particularly preferably 1.0 nm or less, and most preferably 0.50 nm or less.

In the laminated glass 10 according to the present embodiment, the thicknesses of the first glass plate 11 and the second glass plate 12 may be constant over the entire surface, or may be changed for each portion as necessary, such as forming a wedge shape in which the thickness of one or both of the first glass plate 11 and the second glass plate 12 gradually decreases.

The first glass plate 11 or the second glass plate 12 may be a chemically tempered glass that has been subjected to a glass tempering in order to improve the strength. The method of the chemical tempering treatment is the same as the chemical tempering treatment for the glass described above. Examples of the chemically tempered glass include the above alkali aluminosilicate glass and the above alkali aluminoborosilicate glass that have been subjected to a chemical tempering treatment.

The shape of the first glass plate 11 and the second glass plate 12 may be a flat plate shape, or may be a curved shape having a curvature on the entire surface or a part thereof. In the case where the first glass plate 11 and the second glass plate 12 are curved, they may have a single-bent shape that curves only in one direction of either an up-and-down direction or a right-and-left direction, or may have a multi-bent shape that curves both in the up-and-down direction and the right-and-left direction. In the case where the first glass plate 11 and the second glass plate 12 have a multi-bent shape, the curvature radii thereof may be same or different in the up-and-down direction and the right-and-left direction. In the case where the first glass plate 11 and the second glass plate 12 are curved, the curvature radius in the up-and-down direction and/or the right-and-left direction is preferably 1000 mm or more. The shape of the main surface of the first glass plate 11 and the second glass plate 12 is a shape that fits a window opening of a vehicle on which the laminated glass is to be mounted.

The interlayer 13 is sandwiched between the first glass plate 11 and the second glass plate 12. Since the laminated glass 10 according to the present embodiment includes the interlayer 13, the first glass plate 11 and the second glass plate 12 firmly adhere to each other, and an impact force when scattered pieces collide with the glass plates can be reduced.

As the interlayer 13, various organic resins generally used for a laminated glass used as a vehicular laminated glass in the related art can be used. As the organic resin, for example, use can be made of a polyethylene (PE), an ethylene-vinyl acetate copolymer (EVA), a polypropylene (PP), a polystyrene (PS), a methacrylic resin (PMA), polyvinyl chloride (PVC), a polyethylene terephthalate (PET), a polybutylene terephthalate (PBT), cellulose acetate (CA), a diallyl phthalate resin (DAP), a urea resin (UP), a melamine resin (MF), an unsaturated polyester (UP), a polyvinyl butyral (PVB), polyvinyl formal (PVF), polyvinyl alcohol (PVAL), a vinyl acetate resin (PVAc), an ionomer (IO), a polymethylpentene (TPX), a polyvinylidene chloride (PVDC), a polysulfone (PSF), a polyvinylidene difluoride (PVDF), a methacrylate-styrene copolymer resin (MS), a polyarylate (PAR), a polyarylsulfone (PASF), a polybutadiene (BR), a polyethersulfone (PESF), or a polyether ether ketone (PEEK). Among these, EVA and PVB are suitable from the viewpoint of transparency and adhesion, and particularly, PVB can provide sound insulation property, which is more preferred.

The thickness of the interlayer 13 is preferably 0.300 mm or more, more preferably 0.500 mm or more, and still more preferably 0.700 mm or more, from the viewpoint of a reduction in impact force and sound insulation property. In addition, the thickness of the interlayer 13 is preferably 1.00 mm or less, more preferably 0.900 mm or less, and still more preferably 0.800 mm or less, from the viewpoint of preventing a decrease in the visible light transmittance. In addition, the thickness of the interlayer 13 is preferably in a range of 0.300 mm to 1.00 mm, and more preferably in a range of 0.700 mm to 0.800 mm.

The thickness of the interlayer 13 may be constant over the entire surface, or may be changed for each portion as necessary.

Note that, in the case where a difference in the linear expansion coefficient between the interlayer 13 and the first glass plate 11 or the second glass plate 12 is large, when the laminated glass 10 is prepared through a heating step to be described later, the laminated glass 10 may be cracked or warped, resulting in a poor appearance. Therefore, the difference in the linear expansion coefficient between the interlayer 13 and the first glass plate 11 or the second glass plate 12 is preferably as small as possible. The difference in the linear expansion coefficient between the interlayer 13 and the first glass plate 11 or the second glass plate 12 may be represented by the difference between average linear expansion coefficients in a predetermined temperature range.

Particularly, since a resin constituting the interlayer 13 has a low glass transition temperature, a predetermined difference in the average linear expansion coefficient may be set in a temperature range equal to or lower than the glass transition temperature of the resin material. Note that, the difference in the linear expansion coefficient between the resin material and the first glass plate 11 or the second glass plate 12 may be set at a predetermined temperature equal to or lower than the glass transition temperature of the resin material.

As the interlayer 13, an adhesive layer containing an adhesive may be used. The adhesive is not particularly limited, and for example, an acrylic adhesive or a silicone adhesive can be used.

In the case where the interlayer 13 is an adhesive layer, it is not necessary to perform a heating step in the process of bonding the first glass plate 11 and the second glass plate 12, and thus the above-described cracking or warpage is less likely to occur.

### [Other Layers]

The laminated glass 10 according to the present embodiment may include layers other than the first glass plate 11, the second glass plate 12, and the interlayer 13 (hereinafter, also referred to as “other layers”) within a range that does not impair effects of the present embodiment. For example, a coating layer that provides a water repellent function, a hydrophilic function, an anti-fogging function, or the like, or an infrared reflection film may be provided.

Positions where the other layers are provided are not particularly limited, and the other layers may be provided on a surface of the laminated glass 10, or may be sandwiched among the first glass plate 11, the second glass plate 12, and the interlayer 13. In addition, the laminated glass 10 according to the present embodiment may include a black ceramic layer or the like which is disposed in a band shape on a part or all of a peripheral edge portion for the purpose of hiding an attachment portion to a frame body or the like, a wiring conductor, or the like.

The total thickness of the first glass plate 11, the second glass plate 12, and the interlayer 13 is preferably 3.5 mm or more.

In particular, in the case where the laminated glass according to the present embodiment has the above properties, the total thickness of the first glass plate 11, the second glass plate 12, and the interlayer 13 is preferably 3.5 mm or more. In the case where the total thickness is 3.5 mm or more, sound insulation property can be improved. The total thickness is more preferably 4.0 mm or more, still more preferably 4.2 mm or more, even more preferably 4.4 mm or more, particularly preferably 4.6 mm or more, and most preferably 4.8 mm or more.

In addition, the total thickness is preferably 8.0 mm or less, more preferably 7.5 mm or less, still more preferably 7.0 mm or less, particularly preferably 6.5 mm or less, particularly preferably 6.0 mm or less, and most preferably 5.8 mm or less, from the viewpoint of weight reduction. Note that, in the case where the total thickness of the first glass plate 11, the second glass plate 12, and the interlayer 13 varies depending on a position, the total thickness is preferably 3.5 mm or more at the thinnest position.

In the laminated glass according to the present embodiment, the ratio (t₁/t₂) of the thickness t₁ of the first glass plate to the thickness t2 of the second glass plate is preferably 1.7 or more. In the case where the ratio (t₁/t₂) is 1.7 or more, excellent formability and strength can be achieved. The ratio (t₁/t₂) is more preferably 2.0 or more, still more preferably 2.3 or more, even more preferably 2.5 or more, particularly preferably 2.7 or more, and most preferably 3.0 or more. In addition, in order to approximate the curvature when the glass after bending is formed into a laminated glass, the ratio (t₁/t₂) is preferably 17 or less, more preferably 15 or less, still more preferably 10 or less, still more preferably 8.0 or less, particularly preferably 7.0 or less, and most preferably 6.0 or less.

In the case where the laminated glass 10 according to the present embodiment is for a vehicular window glass application, the visible light transmittance Tv defined in ISO-9050:2003 using a D65 light source is preferably 70% or more. Tv is more preferably 71% or more, and still more preferably 72% or more. In addition, Tv is, for example, 90% or less.

In the case where the laminated glass 10 according to the present embodiment is for a vehicular window glass application, the total solar transmittance Tts is preferably 70% or less, as defined in ISO-13837:2008 convention A and measured at a wind speed of 4 m/s. In the case where the total solar transmittance Tts of the laminated glass 10 according to the present embodiment is 70% or less, a sufficient heat-shielding property can be obtained. Tts is more preferably 68% or less, and still more preferably 66% or less. In addition, Tts is, for example, 55% or more.

A method for producing the laminated glass 10 according to the present embodiment may be the same as that for a known laminated glass in the related art. For example, through steps of laminating the first glass plate 11, the interlayer 13, and the second glass plate 12 in this order and performing heating and pressing, the laminated glass 10 having a configuration in which the first glass plate 11 and the second glass plate 12 are bonded to each other via the interlayer 13 can be obtained.

In the method for producing the laminated glass 10 according to the present embodiment, for example, after a step of heating and forming each of the first glass plate 11 and the second glass plate 12, a step of inserting the interlayer 13 between the first glass plate 11 and the second glass plate 12 and performing heating and pressing may be performed. Through such steps, the laminated glass 10 having a configuration in which the first glass plate 11 and the second glass plate 12 are bonded to each other via the interlayer 13 may be obtained.

### Application

The glass according to the present embodiment is for buildings, vehicles, or sensors, and more specifically, can be preferably used as a window glass in a building or a vehicle, or a cover glass of a sensor.

In particular, since the glass according to the present embodiment has excellent durability and formability, the glass is suitable for a window glass in a building or a vehicle, specifically, a member such as a windshield, a side glass, a rear glass, or a roof glass. In addition, from the same viewpoint, the glass can be suitably used particularly as a cover glass for a sensor such as a LiDAR, a camera, or a millimeter-wave radar to be mounted on a vehicle or on an unmanned or manned electric vertical take-off and landing aircraft (eVTOL) such as a drone.

Hereinafter, as a specific application, an example in which the glass according to the present embodiment is used as a vehicular window glass is described with reference to the drawings.

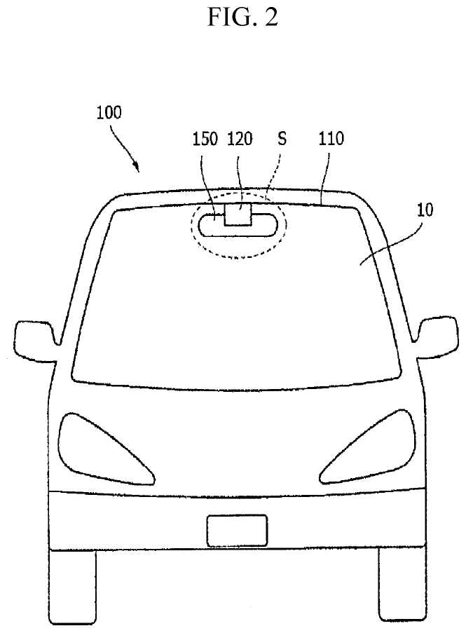

FIG. 2 is a conceptual view illustrating a state where the laminated glass 10 including the glass according to the present embodiment is mounted on an opening 110 formed at a front part of an automobile 100 and used as an automobile window glass.

In the laminated glass 10 used as the automobile window glass, a housing (case) 120 in which an information device or the like is housed for ensuring traveling safety of the vehicle may be attached to a surface on the inner side of the vehicle.

The information device housed in the housing is a device that uses a camera, a radar, or the like to prevent rear-end collision or collision with a preceding vehicle, a pedestrian, an obstacle, or the like in front of the vehicle or to notify a driver of a danger. For example, the information device is an information receiving device and/or an information transmitting device, includes a millimeter-wave radar, a stereo camera, an infrared laser, or the like, and transmits and/or receives a signal. The “signal” is an electromagnetic wave including a millimeter-wave, visible light, infrared light, or the like.

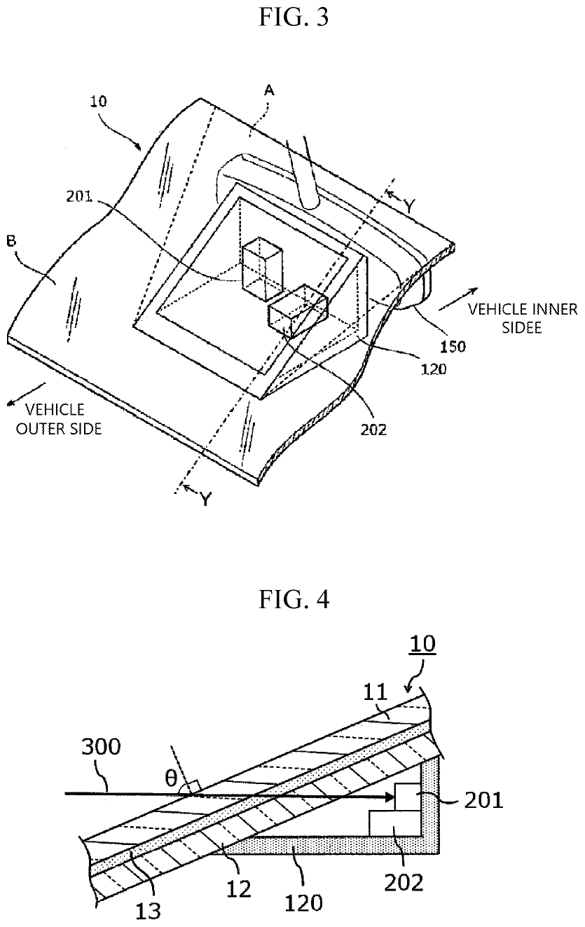

FIG. 3 is an enlarged view of portion S in FIG. 2, and is a perspective view illustrating a portion where the housing 120 is attached to the laminated glass 10 according to the present embodiment. The housing 120 houses a millimeter-wave radar 201 and a stereo camera 202 as the information device. The housing 120 in which the information device is housed is usually attached to the vehicle outer side with respect to a rearview mirror 150 and the vehicle inner side with respect to the laminated glass 10, or may be attached to another portion.

FIG. 4 is a cross-sectional view including line Y-Y in FIG. 3 in a direction orthogonal to the horizontal line. The first glass plate 11 in the laminated glass 10 is preferably disposed on the vehicle outer side. With the above configuration, a windshield that is lightweight and has excellent durability can be implemented. In addition, since the glass according to the present embodiment has a low Young's modulus, it is easy to perform the bending when producing a windshield.

As described above, the following configurations are disclosed in the present specification.

1. A glass for a building, for a vehicle, or for a sensor, containing, in mol % in terms of oxides:
SiO₂: 60% to 68%;
Al₂O₃: 1.5% to 5.0%;
B₂O₃: 0.0% to 5.0%;
MgO: 0.0% to 10%;
CaO: 10% to 20%;
SrO: 0.0% to 10%;
BaO: 0.0% to 5.0%;
Li₂O: 0.0% to 10%;
Na₂O: 0.0% to 20%;
K₂O: 0.0% to 10%;
Y₂O₃: 0.0% to 1.0%;
total iron oxide in terms of Fe₂O₃: 0.0030% to 0.5%;
SiO₂+Al₂O₃+B₂O₃: 62% to 70%;
R′₂O: 14% to 20%; and
RO: 10% to 20% (where RO represents a total content of MgO, CaO, SrO, and BaO, and R′₂O represents a total content of Li₂O, Na₂O, and K₂O).

2. The glass according to the above 1, having a density of 2.55 g/cm³ or more.

3. The glass according to the above 1 or 2, having an average linear expansion coefficient at 50 °C to 350 °C being 95×10⁻⁷/°C or more and 120×10⁻⁷/°C or less.

4. The glass according to any one of the above 1 to 3, satisfying K₂O/R′₂O of 0.50 or less.

5. The glass according to any one of the above 1 to 4, satisfying
MgO/RO of 0.10 or more and
SrO/RO of 0.10 or more.

6. The glass according to any one of the above 1 to 5, which is a bending-formed glass.

7. The glass according to any one of the above 1 to 5, which is a physically tempered glass.

8. The glass according to any one of the above 1 to 7, having a fictive temperature of (glass transition temperature T_{g}+35) °C or higher and 570 °C or higher and 700 °C or lower.

9 A laminated glass containing:
a first glass plate;
a second glass plate; and
an interlayer sandwiched between the first glass plate and the second glass plate, in which
the first glass plate is the glass according to any one of the above 1 to 8.

10. The laminated glass according to the above 9, in which
an absolute value of difference |T_{A}−T_{B}| is 40 °C or less, where T_{A} and T_{B} represent yield points of the first glass plate and the second glass plate, respectively.

11. The laminated glass according to the above 9 or 10, in which a relationship between a plate thickness t1 of the first glass plate and a plate thickness t2 of the second glass plate is t1≥t2.

12. The laminated glass according to any one of the above 9 to 11, in which
a plate thickness t1 of the first glass plate is 2.5 mm or more, and
a plate thickness t2 of the second glass plate is 1.5 mm or less.

13. A vehicular window glass, containing the laminated glass according to t any one of the above 9 to 12.

14. A window glass for building, containing the laminated glass according to any one of the above 9 to 12.

15. A glass for a sensor, containing the laminated glass according to any one of the above 9 to 12.

### EXAMPLES

Hereinafter, the present invention is specifically described with reference to Examples, but the present invention is not limited thereto.

### Production of Glass Plates of Examples 1 to 14

Raw materials were charged into a platinum crucible so as to obtain each glass composition (unit: mol %) shown in Table 1, and melted at a temperature of 1400 °C to 1650 °C for 3 hours to obtain each molten glass. “Fe₂O₃” in Table 1 represents the total iron oxide in terms of Fe₂O₃. The molten glass was poured onto a carbon plate, held at a temperature equal to or higher than the glass transition temperature and equal to or lower than Tu for 3 hours, and then gradually cooled at a condition of an average cooling rate of 1 °C/min. Both surfaces of the obtained plate-shaped glass were polished to obtain a glass plate having a thickness of 3.0 mm. Examples 1 to 7 are Inventive Examples, and Examples 8 to 14 are Comparative Examples.

The results of evaluating the glass plates obtained above as follows are shown in Table 1. Blanks in the table indicate unmeasured values, and italic values indicate calculated values.

(1) Temperature T₂ and Temperature T₄:

The temperature T₂ at which the glass viscosity η reached 10² dPa·s and the temperature T₄ at which the glass viscosity η reached 10⁴ dPa·s, which served as indices for the solubility of the glass, were measured by using a rotational viscometer.

### (2) Liquidus Temperature (T_{L}):

A platinum dish on which 5 g of a glass block cut out from the glass plate was placed was placed in an electric furnace at a different temperature higher than the glass transition point, held for 17 hours, and then taken out of the furnace and cooled. The presence or absence of precipitation on the surface and the inside of the glass block after cooling was examined, and the lowest value of the temperature at the time of holding for 17 hours when crystals were not precipitated was defined as the liquidus temperature.

### (3) Glass Transition Temperature (T_{g}):

The glass transition temperature is a value measured by using TMA and determined according to the standard of JIS R3103-3 (2001).

### (4) Fictive Temperature (T_{f}):

The fictive temperature T_{f} was determined by the following procedures 1) to 3).

1) First, i (i≥2) test pieces were prepared from a glass sample whose fictive temperature was to be measured. Each test piece was placed in an electric furnace and held at different cooling-start temperatures (550 °C, 575 °C, 600 °C, 625 °C, 650 °C, 675 °C, or 700 °C) until the refractive index reached an equilibrium state. Thereafter, each test piece was taken out of the electric furnace at room temperature of 25 °C, and cooled at a cooling rate of 1000 °C/min or more from the cooling-start temperature. 2) The refractive index n_{d} of the glass cooled under the conditions described in 1) was measured at a specific wavelength (for example, the d-line of a He lamp, 587.6 nm). For each cooling-start temperature Tᵢ, the refractive index n_{di} of the glass quenched from the cooling-start temperature was plotted to create a calibration curve. 3) Next, a test piece was cut out from the glass whose fictive temperature T_{f} was to be measured, the refractive index n_{d} of the polished test piece was measured, and the fictive temperature T_{f} of the glass was determined by using the calibration curve.

### (5) Yield Point

The glass of each Example was processed to produce a glass rod having a diameter of 5 mm and a length of 20 mm. A linear expansion curve was measured at a temperature rising rate of 5 °C/min with applying a load of 10 g to a glass rod by using a thermal expansion meter (TD5000SA, manufactured by Bruker AXS Corporation), and a yield point was obtained.

### (6) Average Linear Expansion Coefficient at 50 °C to 350 °C (CTE50-350):

The average linear expansion coefficient was measured by using a differential thermal dilatometer (TMA) and was determined based on the standard in JIS R3102 (1995).

### (7) Density:

The density of about 20 g of a glass block containing no bubble and cut out from the glass plate was measured by Archimedes' method.

### (8) Young's Modulus:

The Young's Modulus was measured at 25 °C by using an ultrasonic pulse method (Olympus, DL35) based on JIS R1602:1995 “Testing methods for elastic modulus of fine ceramics”.

### (9) Rigidity Modulus:

The Rigidity Modulus was measured at 25 °C by using an ultrasonic pulse method (Olympus, DL35) based on JIS R1602:1995 “Testing methods for elastic modulus of fine ceramics”.

### (10) Poisson's Ratio:

The Poisson's ratio was measured at 25 °C by using an ultrasonic pulse method (Olympus, DL35) based on JIS R1602:1995 “Testing methods for elastic modulus of fine ceramics”.

### (11) Fracture Toughness Value

A sample of 65 mm×6.5 mm×6.5 mm was prepared and measured by the DCDC method. At this time, a through hole having a diameter of 2.0 mm was formed on a surface of the sample having a size of 65 mm×6.5 mm, and evaluation was performed.

TABLE 1

| mol % | Ex. 1 | Ex. 2 | Ex. 3 | Ex. 4 | Ex. 5 | Ex. 6 | Ex. 7 |
|---|---|---|---|---|---|---|---|
| SiO₂ | 65.0 | 64.9 | 62.0 | 63.0 | 63.0 | 63.0 | 65.0 |
| Al₂O₃ | 2.0 | 2.0 | 2.0 | 3.0 | 2.0 | 2.0 | 2.0 |
| B₂O₃ | 0.0 | 0.0 | 0.0 | 0.0 | 0.0 | 0.0 | 0.0 |
| MgO | 5.0 | 0.0 | 3.0 | 2.0 | 2.5 | 2.0 | 2.0 |
| CaO | 14.0 | 14.0 | 14.0 | 13.0 | 13.0 | 13.0 | 13.0 |
| SrO | 0.0 | 5.0 | 3.0 | 2.0 | 2.5 | 2.0 | 2.0 |
| BaO | 0.0 | 0.0 | 0.0 | 0.0 | 0.0 | 0.0 | 0.0 |
| Li₂O | 0.0 | 0.0 | 0.0 | 0.5 | 0.5 | 0.5 | 0.0 |
| Na₂O | 14.0 | 14.0 | 14.0 | 15.0 | 15.5 | 17.0 | 15.5 |
| L₂O | 0.0 | 0.0 | 2.0 | 1.5 | 1.0 | 0.5 | 0.5 |
| Y₂O₃ | 0.0 | 0.0 | 0.0 | 0.0 | 0.0 | 0.0 | 0.0 |
| Fe₂O₃ | 0.003 | 0.10 | 0.30 | 0.50 | 0.05 | 0.19 | 0.01 |
| SiO₂ + Al₂O₃ + B₂O₃ | 67 | 67 | 64 | 66 | 65 | 65 | 67 |
| R′₂O | 14.0 | 14.0 | 16.0 | 17.0 | 17.0 | 18.0 | 16.0 |
| RO | 19.0 | 19.0 | 20.0 | 17.0 | 18.0 | 17.0 | 17.0 |
| K₂O/R′₂O | 0.0 | 0.0 | 0.13 | 0.09 | 0.06 | 0.03 | 0.03 |
| MgO/RO | 0.26 | 0.0 | 0.15 | 0.12 | 0.14 | 0.12 | 0.12 |
| SrO/RO | 0.0 | 0.26 | 0.15 | 0.12 | 0.14 | 0.12 | 0.12 |
| T₂ [°C] | 1375 | 1328 | 1307 | 1327 | 1308 | 1290 | 1333 |
| T₄ [°C] | 1035 | 978 | 971 | 976 | 971 | 934 | 957 |
| T_{L} [°C] | >1100 °C | >1100 °C | ≤1100 °C | ≤1100 °C | ≤1070 °C | ≤1050 °C | ≤1080 °C |
| T_{g} [°C] | 568 | 574 | 548 | 538 | 532 | 531 | 556 |
| T_{f} [°C] | | 630 | 590 | 580 | 575 | 575 | 600 |
| Yield Point [°C] | 640 | 640 | 609 | 605 | 595 | 592 | 621 |
| CTE₅₀₋₃₅₀ [×10⁻⁷/°C] | 100 | 101 | 110 | 111 | 112 | 116 | 111 |
| Density [g/cm3] | 2.57 | 2.69 | 2.66 | 2.62 | 2.64 | 2.63 | 2.62 |
| Young's Modulus [GPa] | 78 | 78 | 79 | 79 | 79 | 79 | 77 |
| Rigidity Modulus [GPa] | 32 | 31 | 32 | 32 | 32 | 32 | 31 |
| Poisson's Ratio [—] | 0.24 | 0.24 | 0.25 | 0.24 | 0.24 | 0.25 | 0.24 |
| Fracture Toughness Value | | | 0.77 | | | 0.78 | |
| DCDC method [MPa · m^{1/2}] | | | | | | | |

| mol % | Ex. 8 | Ex. 9 | Ex. 10 | Ex. 11 | Ex. 12 | Ex. 13 | Ex. 14 |
|---|---|---|---|---|---|---|---|
| SiO₂ | 65.0 | 65.0 | 65.0 | 65.0 | 69.6 | 83.5 | 65.2 |
| Al₂O₃ | 0.0 | 2.0 | 0.0 | 0.0 | 0.9 | 1.2 | 11.2 |
| B₂O₃ | 0.0 | 0.0 | 0.0 | 0.0 | 0.0 | 11.6 | 7.9 |
| MgO | 0.0 | 0.0 | 0.0 | 0.0 | 7.1 | 0.0 | 5.7 |
| CaO | 22.5 | 12.0 | 22.5 | 22.5 | 9.1 | 0.0 | 4.9 |
| SrO | 0.0 | 5.0 | 0.0 | 0.0 | 0.0 | 0.0 | 4.8 |
| BaO | 0.0 | 0.0 | 0.0 | 0.0 | 0.0 | 0.0 | 0.0 |
| Li₂O | 0.0 | 0.0 | 0.0 | 0.0 | 0.0 | 0.0 | 0.0 |
| Na₂O | 12.5 | 14.0 | 6.3 | 0.0 | 12.6 | 3.3 | 0.1 |
| L₂O | 0.0 | 0.0 | 6.3 | 12.5 | 0.6 | 0.5 | 0.0 |
| Y₂O₃ | 0.0 | 2.0 | 0.0 | 0.0 | 0.0 | 0.0 | 0.0 |
| Fe₂O₃ | 0.00 | 0.00 | 0.00 | 0.00 | 0.25 | 0.00 | 0.00 |
| SiO₂ + Al₂O₃ + B₂O₃ | 65 | 67 | 65 | 65 | 71 | 96 | 84.3 |
| R′₂O | 12.5 | 14.0 | 12.5 | 12.5 | 13.2 | 3.8 | 0.1 |
| RO | 22.5 | 17.0 | 22.5 | 22.5 | 16.2 | 0.0 | 15.5 |
| K₂O/R′₂O | 0.0 | 0.0 | 0.50 | 1.00 | 0.05 | 0.13 | 0.0 |
| MgO/RO | 0.0 | 0.0 | 0.0 | 0.0 | 0.44 | 0.0 | 0.37 |
| SrO/RO | 0.0 | 0.29 | 0.0 | 0.0 | 0.0 | 0.0 | 0.31 |
| T₂ [°C] | 1312 | 1411 | 1330 | 1356 | 1421 | | |
| T₄ [°C] | 982 | 1033 | 1014 | 1054 | 1025 | | |
| T_{L} [°C] | >1100 °C | | | | | | |
| T_{g} [°C] | 597 | 599 | 59 | 672 | 549 | 525 | 710 |
| T_{f} [°C] | 630 | 630 | 625 | 690 | 580 | 565 | 750 |
| Yield Point [°C] | 660 | 670 | 668 | 730 | 620 | 630 | 805 |
| CTE₅₀₋₃₅₀ [×10⁻⁷/°C] | 101 | 99 | 107 | 103 | 91 | 33 | 38 |
| Density [g/cm3] | 2.63 | 2.77 | 2.61 | 2.59 | 2.51 | 2.22 | 2.51 |
| Young's Modulus [GPa] | 80 | 81 | 77 | 71 | 74 | 62 | 77 |
| Rigidity Modulus [GPa] | 32 | 33 | 31 | 28 | 30 | 26 | 31 |
| Poisson's Ratio [—] | 0.25 | 0.24 | 0.25 | 0.25 | 0.23 | 0.19 | 0.24 |
| Fracture Toughness Value | 0.81 | | 0.75 | | 0.73 | 0.75 | |
| DCDC method [MPa · m^{1/2}] | | | | | | | |

It was found that the glasses of Example 1 to 7, which are Inventive Examples, have a lower yield point and more excellent formability, and also have an equivalent or more excellent Young's modulus, rigidity modulus, Poisson's ratio, and/or fracture toughness value, and exhibits excellent formability and strength, as compared with Example 8 to 14, which are Comparative Examples.

On the other hand, in Comparative Examples 8 and 10, which were Comparative Examples, Al₂O₃ was less than 1.5%, CaO was more than 20%, Fe₂O₃ was less than 0.0030%, R′₂O was less than 14%, and RO was more than 20%, and the fracture toughness value was excellent, but the yield point was high.

In Example 9, which was Comparative Example, Y₂O₃ was more than 1.0%, Fe₂O₃ was less than 0.003%, the average linear expansion coefficient at 50 °C to 350 °C was low, and the yield point was high.

In Example 11, which was Comparative Example, Al₂O₃ was less than 1.5%, CaO was more than 20%, K₂O was more than 10%, Fe₂O₃ was less than 0.0030%, R′₂O was less than 14%, RO was more than 20%, the yield point was high, and Young's modulus and rigidity modulus were low.

In Example 12, which was Comparative Example, SiO₂ was more than 68%, Al₂O₃ was less than 1.5%, CaO was less than 10%, SiO₂+Al₂O₃+B₂O₃ was more than 70%, R′₂O was less than 14%, the yield point was high, and the average linear expansion coefficient at 50 °C to 350 °C, density, Young's modulus, and rigidity modulus were low.

In Example 13, which was Comparative Example, SiO₂ was more than 68%, Al₂O₃ was less than 1.5%, B₂O₃ was more than 5.0%, CaO was less than 10%, Fe₂O₃ was less than 0.003%, SiO₂+Al₂O₃+B₂O₃ was more than 70%, R′₂O was less than 14%, RO was less than 10%, the yield point was high, and the average linear expansion coefficient at 50 °C to 350 °C, density, Young's modulus, and rigidity modulus were low.

In Example 14, which was Comparative Example, Al₂O₃ was more than 5.0%, B₂O₃ was more than 5.0%, CaO was less than 10%, Fe₂O₃ was less than 0.0030%, SiO₂+Al₂O₃+B₂O₃ was more than 70%, R′₂O was less than 14%, the yield point was high, and the average linear expansion coefficient at 50 °C to 350 °C and density were small.

### <Preparation of Laminated Glass>

Laminated glasses in Test Example 1 to Test Example 6 were produced by the following procedure. Test Example 1 to Test Example 6 are Inventive Examples.

### Test Example 1

As the first glass plate, a glass having a thickness of 2.5 mm and a surface roughness Ra of 2.0 nm or less and having a composition shown in Example 6 in Table 1 was used. As the interlayer, a polyvinyl butyral (PVB) having a thickness of 0.78 mm was used. As the second glass plate, a glass having a thickness of 1.5 mm and having a composition shown in Example 12 in Table 1 was used. The first glass plate, the interlayer, and the second glass plate were laminated in this order, pre-bonded at 120 °C for 15 minutes, and then pressure-bonded under conditions of 130 °C and 1 MPa. Thereafter, the temperature was returned to room temperature and the pressure was returned to atmospheric pressure over 90 minutes to prepare a laminated glass in Test Example 1.

In the laminated glass in Test Example 1, the total thickness of the first glass plate, the second glass plate, and the interlayer was 4.8 mm, and the ratio (t₁/t₂) of the thickness t₁ of the first glass plate to the thickness t2 of the second glass plate was 1.7. Further, the absolute value |T_{A}−T_{B}| of the difference when the yield points of the first glass plate and the second glass plate were denoted as T_{A} and T_{B}, respectively was 28 °C.

### Test Examples 2 to 6

Laminated glasses were produced in the same manner as in Test Example 1 except that the glass types and thicknesses of the first glass plate and the second glass plate were as shown in Table 2.

TABLE 2

| | | Test | Test | Test | Test | Test | Test |
|---|---|---|---|---|---|---|---|
| | | Ex. 1 | Ex. 2 | Ex. 3 | Ex. 4 | Ex. 5 | Ex. 6 |
| First glass | Glass kind | Ex. 6 | Ex. 7 | Ex. 6 | Ex. 7 | Ex. 2 | Ex. 6 |
| plate | Thickness [mm] | 2.5 | 3.0 | 3.5 | 3.5 | 3.5 | 3.3 |
| Interlayer | Interlayer kind | PVB | PVB | PVB | PVB | PVB | PVB |
| | Thickness [mm] | 0.78 | 0.78 | 0.78 | 0.78 | 0.78 | 0.78 |
| Second glass | Glass kind | Ex. 12 | Ex. 12 | Ex. 12 | Ex. 12 | Ex. 12 | Ex. 13 |
| plate | Thickness [mm] | 1.5 | 1.0 | 1.5 | 1.1 | 1.2 | 1.3 |

| | | | | | | |
|---|---|---|---|---|---|---|
| Total thickness of laminated glass [mm] | 4.8 | 4.8 | 5.8 | 5.4 | 5.5 | 5.4 |
| Ratio (t₁/t₂) of thickness t₁ of first glass | 1.7 | 3.0 | 2.3 | 3.2 | 2.9 | 2.5 |
| plate to thickness t₂ of second glass plate | | | | | | |
| \|T_{A} − T_{B}\| of yield point difference [°C] | 28 | 1 | 28 | 1 | 20 | 38 |

Although the present invention has been described in detail with reference to specific aspects, it is apparent to those skilled in the art that various changes and modifications can be made without departing from the spirit and scope of the present invention. Note that, the present application is based on a Japanese patent application (Japanese Patent Application No. 2023-221647) filed on Dec. 27, 2023, the entire contents of which are incorporated herein by reference. In addition, all references cited here are entirely incorporated.

### REFERENCE SIGNS LIST

10 Laminated glass
11 First glass plate
12 Second glass plate
13 Interlayer
100 Automobile
110 Opening
120 Housing
150 Rearview mirror
201 Millimeter-wave radar
202 Stereo camera
300 Radio wave

What is claimed is:

1. A glass for a building, for a vehicle, or for a sensor, comprising, in mol % in terms of oxides:
SiO₂: 60% to 68%;
Al₂O₃: 1.5% to 5.0%;
B₂O₃: 0.0% to 5.0%;
MgO: 0.0% to 10%;
CaO: 10% to 20%;
SrO: 0.0% to 10%;
BaO: 0.0% to 5.0%;
Li₂O: 0.0% to 10%;
Na₂O: 0.0% to 20%;
K₂O: 0.0% to 10%;
Y₂O₃: 0.0% to 1.0%;
total iron oxide in terms of Fe₂O₃: 0.0030% to 0.5%;
SiO₂+Al₂O₃+B₂O₃: 62% to 70%;
R′₂O: 14% to 20%; and
RO: 10% to 20% (where RO represents a total content of MgO, CaO, SrO, and BaO, and R′₂O represents a total content of Li₂O, Na₂O, and K₂O).

2. The glass according to claim 1, having a density of 2.55 g/cm³ or more.

3. The glass according to claim 1, having an average linear expansion coefficient at 50 °C to 350 °C being 95×10⁻⁷/°C or more and 120×10⁻⁷/°C or less.

4. The glass according to claim 1, satisfying K₂O/R′₂O of 0.50 or less.

5. The glass according to claim 1, satisfying MgO/RO of 0.10 or more and SrO/RO of 0.10 or more.

6. The glass according to claim 1, which is a bending-formed glass.

7. The glass according to claim 1, which is a physically tempered glass.

8. The glass according to claim 1, having a fictive temperature of (glass transition temperature T_{g}+35) °C or higher and 570 °C or higher and 700 °C or lower.

9. The glass according to claim 1, having a transmittance at a wavelength of 905 nm or 1550 nm in terms of a thickness of 4.0 mm being 86% or more.

10. A laminated glass comprising:
a first glass plate;
a second glass plate; and
an interlayer sandwiched between the first glass plate and the second glass plate, wherein
the first glass plate is the glass according to claim 1.

11. The laminated glass according to claim 10, wherein
an absolute value of difference |T_{A}−T_{B}| is 40 °C or less, where T_{A} and T_{B} represent yield points of the first glass plate and the second glass plate, respectively.

12. The laminated glass according to claim 10, wherein
a relationship between a plate thickness t1 of the first glass plate and a plate thickness t2 of the second glass plate is t1≥t2.

13. The laminated glass according to claim 12, wherein
the plate thickness t1 of the first glass plate is 2.5 mm or more, and
the plate thickness t2 of the second glass plate is 1.5 mm or less.

14. A vehicular window glass, comprising the laminated glass according to claim 10.

15. The vehicular window glass according to claim 14, wherein
the laminated glass has:
a visible light transmittance Tv defined in ISO-9050:2003 using a D65 light source being 70% or more, and
a total solar transmittance Tts defined in ISO-13837:2008 convention A being 70% or less, and
the first glass plate is disposed on the vehicle outer side.

16. A window glass for building, comprising the laminated glass according to claim 10.

17. A glass for a sensor, comprising the laminated glass according to claim 9.
